(19) United States
(12) Patent Application Publication
(10) Pub. No.: US 2016/0055683 A1
(43) Pub. Date: Feb. 25, 2016

(54) ATTENDANCE CHECKING DEVICE

(71) Applicant: Man-Chee LIU, Taipei City (TW)

(72) Inventor: Man-Chee LIU, Taipei City (TW)

(21) Appl. No.: 14/582,280

(22) Filed: Dec. 24, 2014

(30) Foreign Application Priority Data
Aug. 22, 2014 (TW) 103215102

(51) Int. Cl. G07C 1/10

(52) U.S. Cl. CPC G07C 1/10

(57) ABSTRACT

The present invention provides an attendance checking device, which includes: a hand-held terminal having a first battery, a first controller, a first displayer and a first wireless module, wherein the first wireless module is able to emit a wireless inquiring signal; and at least one wireless tag having a second battery, a second controller, a second displayer and a second wireless module, wherein the second wireless module is able to receive the wireless inquiring signal and send back an acknowledge signal to the first wireless module, and the acknowledge signal is displayed on the first displayer for enabling the user of the hand-held terminal to know the status of the user of the wireless tag. Accordingly, the attendance checking device is able to achieve a function of automatic attendance checking.

### BACKGROUND OF THE INVENTION

1. Field of the Invention

The present invention relates to an attendance checking device, especially to an attendance checking device having a hand-held terminal and at least one wireless tag, wherein the hand-held terminal is used by a tour guide and the at least one wireless tag is worn by at least one tourist, thereby enabling the attendance checking device to achieve an objective of automatic attendance checking.

2. Description of Related Art

The living standard of people has been being increasing, so both domestic and foreign tourism businesses are well developed. As we all know, each tour group is provided with a tour guide, the tour guide is not only in charge of planning the tour schedule but also accountable for checking each tourist for avoiding the situation of any tourist being missing. As such, attendance checking and finding lost tourists are always a huge work load for the tour guide, so how to reduce the work load of a tour guide shall be seriously concerned.

At present, a wireless device used in tourism related field is mainly for wirelessly providing a description of a tourist attraction or explaining some tour details to the involved tourists, so a problem of a speaker poorly delivering audio effect can be solved, however the transmission distance is very limited, thereby unable to achieve effects of attendance checking or calling the involved tourists, and the cost is relatively higher. As such, the wireless device is only used in some high-end places such as a museum or an exhibition hall.

Take the Taiwan Patent NO.I322396, titled in “Mobile classroom feedback system” for example, a client-server mode is adopted therein, and a mobile hand-held device (e.g. a mobile phone, a personal digital assistance (PDA) or a notebook computer) utilizes a wireless network (e.g. GPRS, WiFi or 3G) for transmission, so the student's opinion on certain issues can be timely collected with an anonymous or non-anonymous means, the student's opinion includes answers to a test or a quiz (multiple choice questions, essay questions or fill-in-the-blank questions) or the questions provided by students in the classroom; thus all the feedbacks provided by students can be immediately displayed on a notebook computer used by the teacher in the classroom, and the teacher is able to take advantage of this system for planning the teaching material or modifying the teaching material with respect to the timely responses provided by the students, and the design of the teaching material can also be included in the system, thereby allowing the system to be used for increasing the interaction between the teacher and the students so as to enhance the learning willingness of students.

Take the Taiwan Patent NO.M346222, titled in “Object monitoring system utilizing short-distance wireless communication technology” for instance, in which at least one target object and a hand-held device are included, the target object includes a controlled device allowing the data to be transmitted with the hand-held device through a short-distance communication means. Because the controlled device is provide with certain parameters, the hand-held device is enabled to timely monitor a certain controlled device or target object through a mechanism of automatic checking in or parameter identifying; in addition, the hand-held device is also able to send the lighting control command complying with the DMX 512 protocol for wirelessly controlling the lighting effect; moreover, an outdoor street lamp installed with the controlled device is able to be controlled by the hand-held device and a node can be formed for allowing a plurality of street lamps to establish a network so as to enable the emergency rescue signal sent by the hand-held device to be remotely transmitted, thereby forming a free and effective security network.

However, the above-mentioned patents do not provide any feature allowing a tour guide to process individual attendance checking, automatic attendance checking, group attendance checking and regular attendance checking to the tourists.

In view of the above-mentioned shortages existed in the conventional wireless communication system, the present invention provides an attendance checking device for improving said shortages.

### SUMMARY OF THE INVENTION

One primary objective of the present invention is to provide an attendance checking device having a hand-held terminal and at least one wireless tag, wherein the hand-held terminal is used by a tour guide and the at least one wireless tag is worn by at least one tourist, thereby enabling the attendance checking device to achieve functions of individual attendance checking, automatic attendance checking, group attendance checking and regular attendance checking.

Another objective of the present invention is to provide an attendance checking device, wherein a hand-held device is used by a tour guide, and at least one wireless tag is used by at least one tourist, and each of the wireless tags is formed with a unique identification code.

For achieving said objectives, one technical solution provided by the present invention is to provide an attendance checking device, which includes: a hand-held terminal having a first battery, a first controller, a first displayer and a first wireless module, wherein the first wireless module is able to emit a wireless inquiring signal; and at least one wireless tag having a second battery, a second controller, a second displayer and a second wireless module, wherein the second wireless module is able to receive the wireless inquiring signal and send back an acknowledge signal to the first wireless module, and the acknowledge signal is displayed on the first displayer for enabling the user of the hand-held terminal to know the status of each user of the wireless tag.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is block diagram illustrating the hand-held terminal according to one preferred embodiment of the present invention;

FIG. 2 is block diagram illustrating the wireless tag according to one preferred embodiment of the present invention; and

FIG. 3 is a schematic view illustrating the attendance checking device being in use according to one preferred embodiment of the present invention.

### DETAILED DESCRIPTION OF THE PREFERRED EMBODIMENT

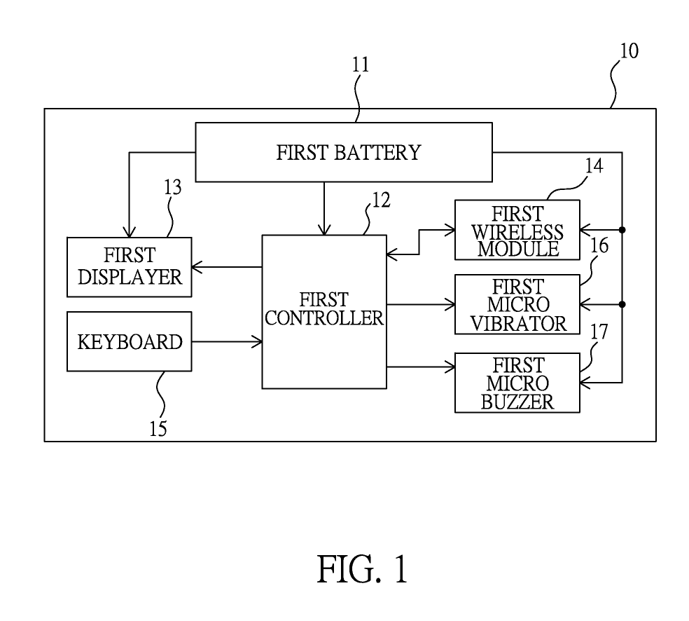

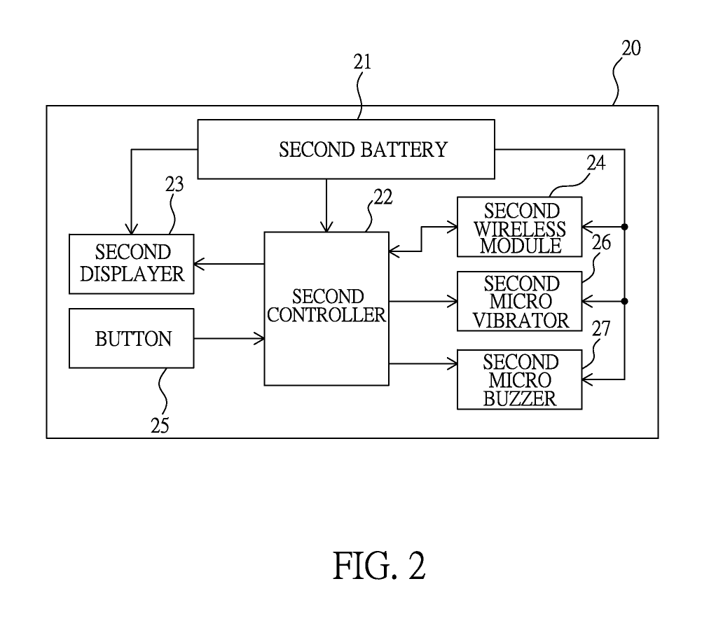

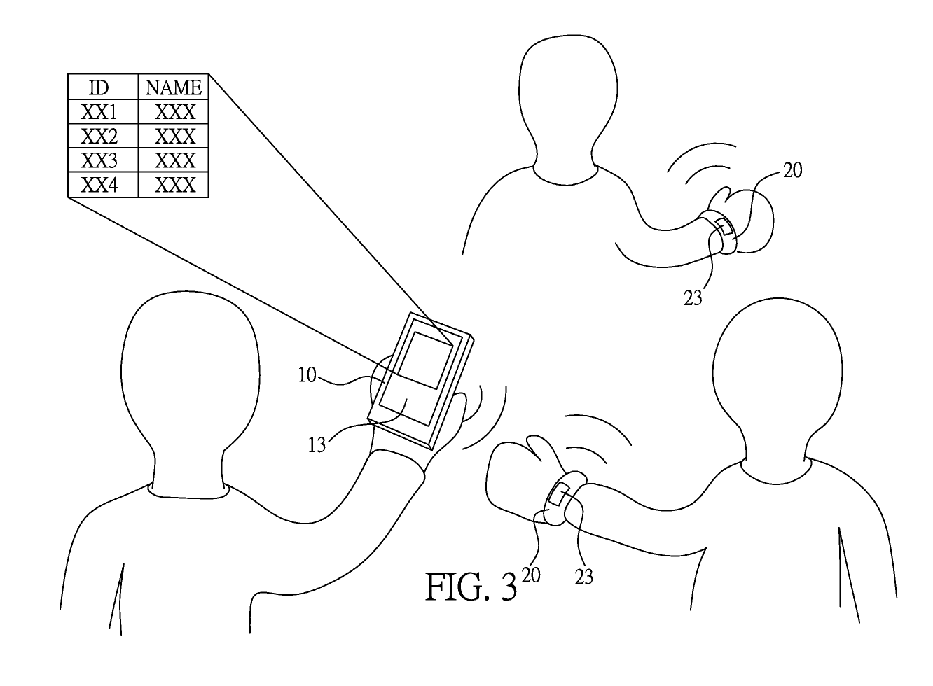

Referring from FIG. 1 to FIG. 3, wherein FIG. 1 is block diagram illustrating the hand-held terminal according to one preferred embodiment of the present invention; FIG. 2 is block diagram illustrating the wireless tag according to one preferred embodiment of the present invention; and FIG. 3 is a schematic view illustrating the attendance checking device being in use according to one preferred embodiment of the present invention.

As shown in figures, the present invention provides an attendance checking device, which is used in a tourism system and incudes a hand-held terminal 10 and at least one wireless tag 20.

The hand-held terminal 10, e.g. but not limited to a smart phone, a tablet computer, a personal digital assistance or a wearable device, is used by a tour guide and includes a first battery 11, a first controller 12, a first displayer 13 and a first wireless module 14, wherein the first wireless module 14 is able to emit a wireless inquiring signal. Wherein, the first battery 11 is e.g. but not limited to a lithium-ion battery and respectively coupled to the first controller 12, the first displayer 13 and the first wireless module 14, thereby enabling a required DC power source to be inputted for operation. The first controller 12 is e.g. but not limited to a microcontroller, and the first controller 12 is installed with an application program; the first displayer 13 is e.g. but not limited to a 3-inch liquid crystal display and coupled to the first controller 12, thereby allowing the application program to be displayed; the first wireless module 14 is coupled to the first controller 12 and capable of emitting a wireless inquiring signal for processing an attendance checking operation. In addition, the hand-held terminal 10 is able to be connected to a computer (not shown in figures) thereby enabling the computer to manage or update the application program.

The at least one wireless tag 20, e.g. but not limited to a bracelet worn on each of tourists at the location e.g. but not limited to his/her wrist, waist or chest; and each of the wireless tags 20 is formed with a unique identification code and includes a second battery 21, a second controller 22, a second displayer 23 and a second wireless module 24, wherein the second wireless module 24 is able to emit a wireless inquiring signal. Wherein, the second battery 21 is e.g. but not limited to a lithium-ion battery and respectively coupled to the second controller 22, the second displayer 23 and the second wireless module 24, thereby enabling a required DC power source to be inputted for operation. The second controller 22 is e.g. but not limited to a microcontroller; the second displayer 23 is e.g. but not limited to a 1-inch liquid crystal display; and the second wireless module 24 is coupled to the second controller 22 for receiving the wireless inquiring signal emitted by the first wireless module 14 and sending back an acknowledge signal to the first wireless module 14, and the acknowledge signal is displayed on the first displayer 13 for enabling the tour guide to know the attendance checking status of each of the users having the wireless tags 20 through the application program of the hand-held terminal 10.

Moreover, the hand-held terminal 10 of the present invention further includes a keyboard 15 coupled to the first controller 11, so the tour guide can use the keyboard 15 to input the unique identification code of the wireless tag 20 and the personal information (e.g. but not limited to the ID number) of the tourist wearing the wireless tag 20 into the application program, thereby enabling the unique identification code of each of the wireless tags 20 to be matched with the personal information of each of the tourists so as to allow the hand-held terminal 10 to process an identifying operation. Furthermore, the working frequency of the first wireless module 14 of the hand-held terminal 10 and the working frequency of the second wireless module 24 of each of the wireless tags 20 are switchable, so a situation of the frequencies of the plural hand-held terminals 10 being interfered with each other can be avoided when the tour guides of a plurality of tourist groups are using the hand-held terminals 10 at the same tourist attraction.

In addition, the hand-held terminal 10 of the present invention further includes a first micro vibrator 16 coupled to the first controller 11 for emitting a vibrating warning signal.

Moreover, the hand-held terminal 10 of the present invention further includes a first micro buzzer 17 coupled to the first controller 11 for emitting an audio warning signal.

Furthermore, the wireless tag 20 of the present invention further includes a button 25 coupled to the second controller 22 for inputting a signal into the second controller 22.

Furthermore, the wireless tag 20 of the present invention further includes a second micro vibrator 26 coupled to the second controller 22 for emitting a vibrating warning signal.

Furthermore, the wireless tag 20 of the present invention further includes a second micro buzzer 27 coupled to the second controller 22 for emitting an audio warning signal.

As shown in FIG. 3, when the attendance checking device provided by the present invention is in use, the tour guide inputs the unique identification code of each of the wireless tags 20 and the personal information of each of the tourists into the application program of the hand-held terminal 10; when the tour group is going out, the tour guide is able to use the hand-held terminal 10 to process an attendance checking operation to the tourists wearing the wireless tags 20 and located within a distance of 5 meters, wherein the attendance checking operation can be categorized into individual attendance checking, group attendance checking, automatic attendance checking, regular attendance checking and automatic calling for help; each type of attendance checking operation is illustrated as following.

The individual attendance checking is defined as the tour guide uses the hand-held terminal 10 to process a calling and confirming operation to the wireless tag 20 worn by a certain tourist, after the certain tourist receives a calling and conforming signal, an acknowledge signal is sent to the first wireless module 14 for the purpose of checking in, meanwhile the checking in status is displayed on the application program of the first displayer 13, thereby enabling the tour guide to easily process the individual attendance checking.

The group attendance checking is defined as the tour guide uses the hand-held terminal 10 to process a calling and confirming operation to the wireless tags 20 worn by a certain group of tourists, after the certain group of tourists all receive the calling and conforming signal, an acknowledge signal is respectively sent to the first wireless module 14 for the purpose of checking in, meanwhile the checking in status is displayed on the application program of the first displayer 13, thereby enabling the tour guide to easily process the group attendance checking.

The automatic attendance checking is defined as being processed in a small place such as in a tour bus, the tour guide is able to use the hand-held terminal 10 to process an automatic calling and confirming operation to the wireless tags 20 worn by each of the tourists passing the vehicle door, and the wireless tag 20 of each of the tourists respectively sends back an acknowledge signal to the first wireless module 14 for the purpose of checking in, so the tour guide can timely monitor the checking in status within the distance of 5 meters through the application program of the first displayer 13; if the vehicle has been driven by 10 meters and there are still some tourists not being on the vehicle, the first micro vibrator 16 and the first micro buzzer 17 of the hand-held terminal 10 can be served to respectively send a warning signal for informing the tour guide to stop the vehicle.

The regular attendance checking is defined as being processed in a large place such as in a big shopping mall, the tour guide is able to use the hand-held terminal 10 to set a checking in time to the wireless tag 20 worn by each of the tourists, if the tourists have not checked in after the preset time, the second micro vibrator 26 and the second micro buzzer 27 of the wireless tag 20 can be served to respectively send a warning signal for informing the tourist to rapidly get back to the tour group.

The automatic calling for help is defined as when the second micro vibrator 26 and the second micro buzzer 27 of the wireless tag 20 have already emitted the warning signal and such situation have been going on for more than three hours, and the hand-held terminal 10 has not yet received any signal, then the wireless tag 20 worn by the tourist is turned into an automatic calling for help status for allowing other personnel to search for the certain tourist for providing a timely positioning and rescuing function. Accordingly, the attendance checking device provided by the present invention is novel and more practical in use comparing to prior art.

Based on what has been disclosed above, the attendance checking device provided by the present invention includes a hand-held terminal and at least one wireless tag, wherein the hand-held terminal is used by a tour guide and the at least one wireless tag is worn by one or a plurality of tourists, so the attendance checking device is provided with functions of individual attendance checking, automatic attendance checking, group attendance checking and regular attendance checking. Accordingly, the attendance checking device provided by the present invention is novel and more practical in use comparing to prior art.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

1. An attendance checking device for a tour guide, including:
a hand-held terminal, having a first battery, a first controller, a first displayer and a first wireless module, wherein said first wireless module being able to emit a wireless inquiring signal to at least one wireless tag; and
at least one wireless tourist tag, the tag having a unique identification code and having a second battery, a second controller, a second displayer and a second wireless module, wherein said second wireless module being able to receive said wireless inquiring signal and send back an acknowledge signal to said first wireless module, and said acknowledge signal being displayed on said first displayer for enabling a user of said hand-held terminal to know the status of a user of said wireless tag.

2. (canceled)

3. The attendance checking device as claimed in claim 1, wherein said first controller is a microcontroller, said first displayer is a liquid crystal display, said first wireless module is a RF (radio frequency) module, said second controller is a microcontroller, said second displayer is a liquid crystal display, and said second wireless module is a RF (radio frequency) module.

4. The attendance checking device as claimed in claim 1, wherein said hand-held terminal is a smart phone, a tablet computer, a personal digital assistance or a wearable device, and said wireless tag is a bracelet.

5. The attendance checking device as claimed in claim 1, wherein said hand-held terminal further includes a keyboard, and said first controller is further installed with an application program, so said user is able to use said keyboard to input said unique identification code of said wireless tag and the personal information of a user into said application program, thereby enabling said unique identification code to be matched with said personal information of said user.

6. The attendance checking device as claimed in claim 1, wherein said hand-held terminal further includes a first micro vibrator coupled to said first controller for emitting a vibrating warning signal.

7. The attendance checking device as claimed in claim 1, wherein said hand-held terminal further includes a first micro buzzer coupled to said first controller for emitting an audio warning signal.

8. The attendance checking device as claimed in claim 1, wherein said wireless tag further includes a button coupled to said second controller for inputting a signal into said second controller.

9. The attendance checking device as claimed in claim 1, wherein said wireless tag further includes a second micro vibrator coupled to said second controller for emitting a vibrating warning signal.

10. The attendance checking device as claimed in claim 1, wherein said wireless tag further includes a second micro buzzer coupled to said second controller for emitting an audio warning signal.
